(19) United States
(12) Patent Application Publication
(10) Pub. No.: US 2006/0143398 A1
(43) Pub. Date: Jun. 29, 2006

(54) Method and apparatus for least recently used (LRU) software cache

(76) Inventor: Stefan Rau, Dielheim (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/021,707

(22) Filed: Dec. 23, 2004

(51) Int. Cl. G06F 13/00

(52) U.S. Cl. 711/136

(57) ABSTRACT

A data cache has a number of rows. A corresponding list of the rows is maintained, the list including a number of entries, each entry corresponding to a row and including a key uniquely identifying the row, and a count indicating an age of the row. Updating the cache involves sorting the entries by their key, searching the list for an entry having a key to a row to be updated if found or added if not found. If the entry having the key to the row to be updated is found, the entry is removed from the list, the remaining entries are sorted by their count, so that the entry at the beginning of the list is for the oldest row, and the entry at the end of the list is for the newest row, a new entry is appended at the end of the list that replaces the removed entry, the new entry having the same key as the removed entry, and a count indicating the corresponding row is the newest. The corresponding row in the data cache is then updated.

### BACKGROUND

1. Field of the Invention

This invention relates generally to caching. In particular, the invention relates to a least recently used (LRU) software cache.

2. Description of the Related Art

A cache in a memory of a computing system provides for fast look up of data in the cache rather than a slow look up of the data in a permanent store, such as a database stored on a hard disk. In an LRU cache, the oldest data in the cache is removed to make room for new data to be loaded into the cache. When an application requests data, the cache is searched for the requested data. If the requested data is present, the data is copied from the cache to the application in response to the request. If the requested data is not present, the request is serviced by a slower data storage facility, for example, a hard disk drive, to retrieve the data.

In the prior art, improvements in cache performance typically are obtained by increasing the cache size. What is needed is an increase in cache performance while maintaining a maximum cache size.

### SUMMARY

In an embodiment of the invention, a list is maintained corresponding to rows in an LRU cache of limited size. Updating the cache involves searching and replacing an existing entry in the list with a new entry relating to the row being updated in or added to the cache, and updating or adding the corresponding row in the cache.

### BRIEF DESCRIPTION OF THE DRAWINGS

The appended claims set forth the features of the invention with particularity. The embodiments of the invention, together with its advantages, may be best understood from the following detailed description taken in conjunction with the accompanying drawings in which:

FIGS. 1A and 1B is a diagram of a cache table and LRU list according to one embodiment of the invention

FIG. 2 is a diagram of an LRU list according to one embodiment of the invention;

FIGS. 3A and 3B is a diagram of a cache table and LRU list according to one embodiment of the invention;

FIG. 4 is a diagram of an LRU list according to one embodiment of the invention;

FIGS. 5A and 5B is a diagram of a cache table and LRU list according to one embodiment of the invention;

FIGS. 6A and 6B is a diagram of a cache table and LRU list according to one embodiment of the invention;

FIGS. 7A and 7B is a diagram of a cache table and LRU list according to one embodiment of the invention;

FIG. 8 is a diagram of an LRU list according to one embodiment of the invention; and

FIG. 9 is a flow diagram of an embodiment of the invention.

### DETAILED DESCRIPTION

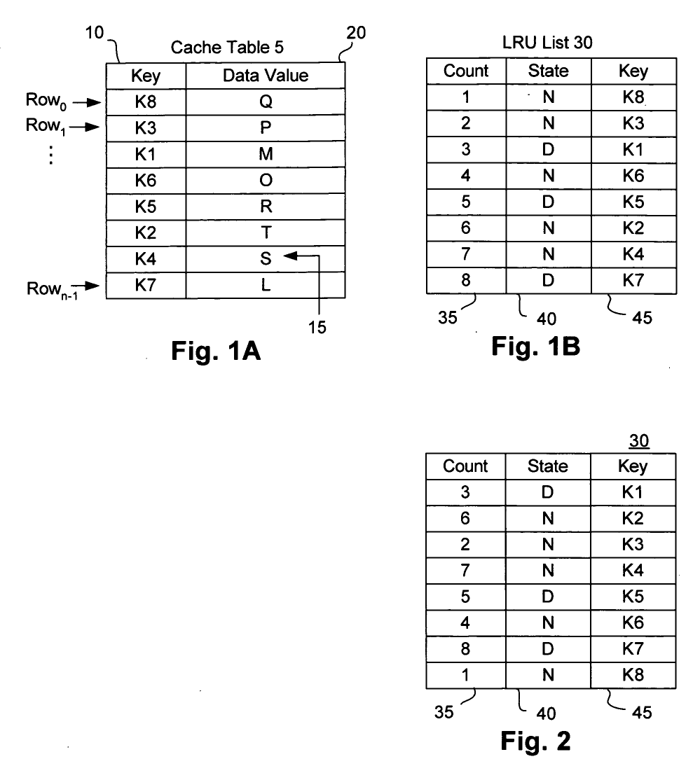

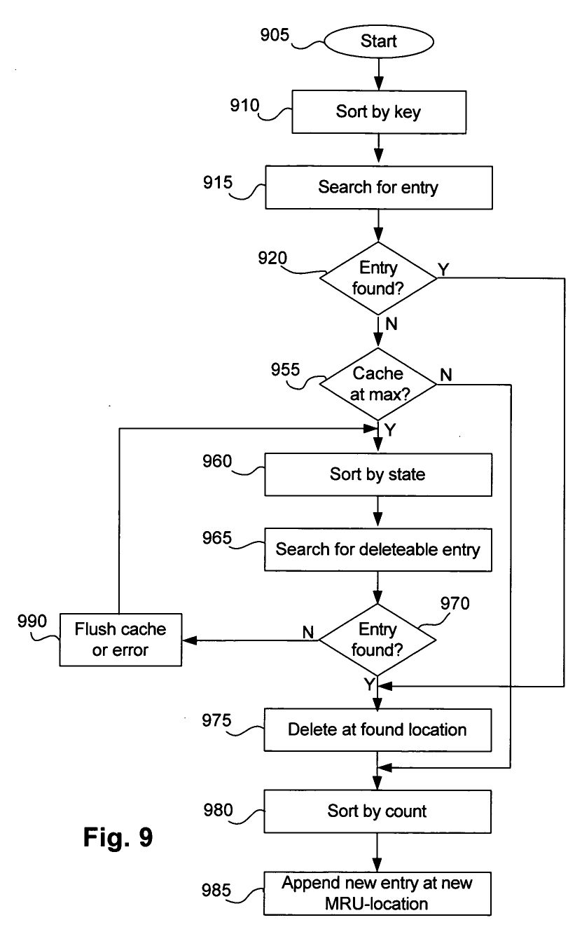

With reference to FIG. 9, an embodiment of the invention updates or adds data to a least-recently-used (LRU) software cache. FIGS. 1-8 diagram the LRU cache table and corresponding LRU list at various stages of the update and/or add process set forth in FIG. 9, and as described below.

FIG. 1A illustrates a simple LRU cache table 5 (“cache” 5) for purposes of explaining the invention. The cache includes a number of rows: rows₀, row-rowₙ₋₁. Each row contains a key field 10 (“key” 10), the content of which may be randomly calculated, for example, using a hash function, at the time the data value is added to the cache, to uniquely identify the data value in the accompanying data value field 20 (“value” 20) in the same row. It should be noted that references hereafter to a key or a value in a row of the cache generally mean the respective contents of the key field or data value field, but may mean the fields themselves, depending on the context in which the terms are used.

A LRU list 30 (“list” 30), shown in FIG. 1B, corresponds to the cache 5. The list includes a number of entries, each entry corresponding to a row in the cache. Each entry in the list includes a key field 45 (“key” 45) uniquely identifying a row in the cache to which the entry corresponds. Each entry further comprises a count field 35 (“count” 35) indicating the age of the corresponding row. In one embodiment of the invention, the count may be a timestamp indicating when the row was added to, or last updated in, the cache. In another embodiment, the count may be a value that indicates the relative age of the row compared to other rows in the cache.

Finally, each entry in the list further includes a state field 40 (“state” 40) indicating whether the corresponding row in the cache table is dirty (represented by “D” in the state field of the LRU list) or not dirty (represented by “N” in the state field of the LRU list). It should be noted that references hereafter to the count, state and key in an entry of the list generally mean the respective contents of the count, state and key fields, but may mean the fields themselves, depending on the context in which the terms are used. A dirty entry, D, in the list indicates that the corresponding row in the cache has been modified but not written to permanent storage, whereas a non-dirty entry, N, in the list indicates that the corresponding row in the cache has not been written to or modified since the row was placed in the cache, or at least since the cache or that entry has been written to permanent storage.

The goal of the process of updating the cache, whether by adding a new row or updating an existing row, according to an embodiment of the invention, is to place a new data element (row) in the cache and if need be displace the oldest row in the cache. The cache is a simple, unsorted list. New rows are appended to the end of the cache and old rows are removed wherever such old rows are located in the cache.

With reference to FIG. 9, the process for updating a row or adding a new row to the cache begins at 905, at which point the state of the cache is such that the oldest rows (least recently used—LRU) are at the top (beginning) of the cache, while the newest rows (most recently used—MRU) are at the bottom (end) of the cache. See FIG. 1A. The oldest corresponding entry in the list with the lowest count value (oldest age) of 1 is the first entry in the list, whereas the newest corresponding entry in the list with a count of 8 is the last entry in the list. As can be seen in the accompanying list in FIG. 1B, certain of the data values in the cache have been modified since the values were last written to a permanent store, namely, those rows whose corresponding entry in the list has a state of dirty, as indicated by D in the state field.

In the example that follows a new value is to be updated in, or added to, a row in the cache. In particular, the value S at key K4, and referenced at 15 in FIG. 1A, is to be updated with a new value N. The first step of the process at 910 involves sorting the entries in list 30 by key. The result of sorting the entries by key is illustrated in FIG. 2. Note that the cache table itself remains unsorted—only the corresponding LRU list is sorted. After sorting, the list is searched at 915 for an entry having a key to the corresponding row in the cache to be updated, if found, or added, if not found. In one embodiment of the invention, a binary search may be performed using the key of the row to be updated. In any case, the key K4 is found at 920 (in the fourth entry of the list 30 in FIG. 2), so the process next removes the entry from the list at 975.

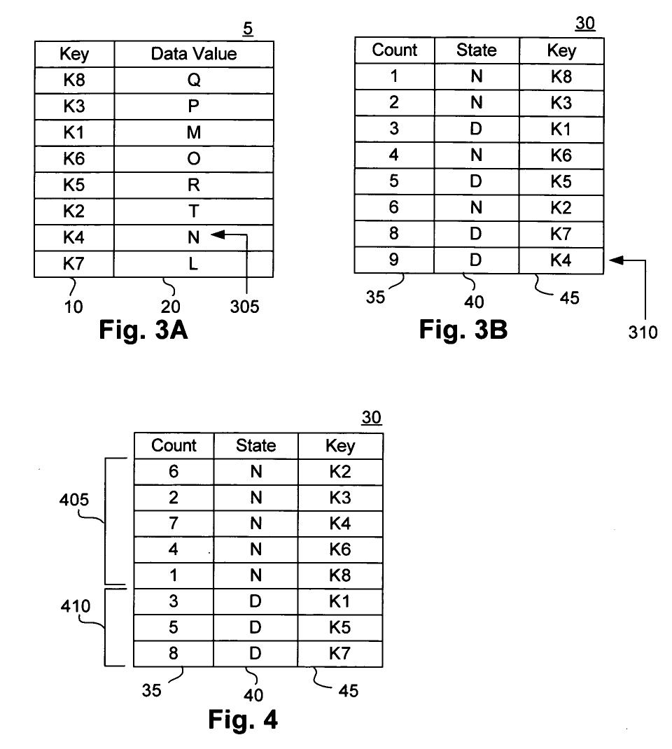

At 980, the remaining entries in the list are sorted based on their count so that the entry at the beginning of the list represents the oldest (least recently used) row in the cache, and the entry at the end of the list represents the newest (most recently used) row in the cache. See, for example, the first eight entries in FIG. 3B, and note no entry exists with a count of 7, indicating removal of the entry from the list at 975. At 985 a new entry 310 is appended to the end of the list that replaces the entry removed at 975. Note the key for the entry is the same as the key for the removed entry, but the count is set to a value of 9, the highest count in the list, to indicate the corresponding row in the cache (referenced at 305 in FIG. 3A) is the most recently used. In combination with adding the new entry 310 in the list, the corresponding value in row 305 of the cache is updated with the new value “N”, replacing the old value “S”. (Note: the value “N” in the cache entry 305 is not to be confused with a value “N” in the state field 45 in the corresponding list. In the cache entry 305, “N” happens to be the data value provided in this example).

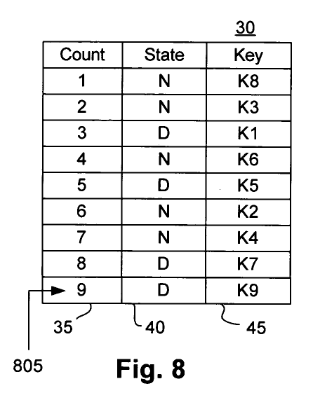

Referring back to the search for an entry in the list at 915 (the entry having a key to a corresponding row in the cache to be added or updated), if the entry is not found at 920, it is added to the list, and the corresponding row added to the cache, as follows, with reference to FIG. 9. If the cache is not full at 955, the entries in the list are sorted at 980 based on their count, that is, their age, as depicted in the list in FIG. 8. Upon sorting, an entry at the beginning of the list corresponds to the oldest row in the cache, and the entry at the end of the list corresponds to the newest row in the cache. A new entry is then created in the list (see reference 805 in FIG. 8) with a next counter value of 9 and a new key of K9 in this example. Likewise, a counterpart row is created at the end of cache, with a key of K9 and a data value (not shown).

With reference again to 915 in FIG. 9, if when searching for an entry to update or add to the list, the entry is not found at 920 and needs to be added, but the cache is full at 955, an embodiment of the invention proceeds to 960, wherein the list is sorted by state, with not dirty entries first and dirty entries last, so that an embodiment of the invention can locate at 970 a corresponding row in the cache that can be removed at 975 to make room for the new row to be added in the cache. See for example, FIG. 4, in which the entries in FIG. 3B are sorted based on the state field 40 values.

In FIG. 4, the first five entries referenced at 405 all have a state of not dirty—any of these entries can be safely deleted since the corresponding rows in the cache have not been modified. Note that while the first five entries are also sorted by key in ascending order, this need not be done in all embodiments of the invention. The last three entries referenced at 410 all have a state of dirty, so deleting corresponding rows in the cache could cause inconsistent results because the data in the cache has been modified since the last read from permanent store; a write of these cache rows should occur before these row are deleted. Also note that while the last three entries are sorted by key, not all embodiments of the invention need do so.

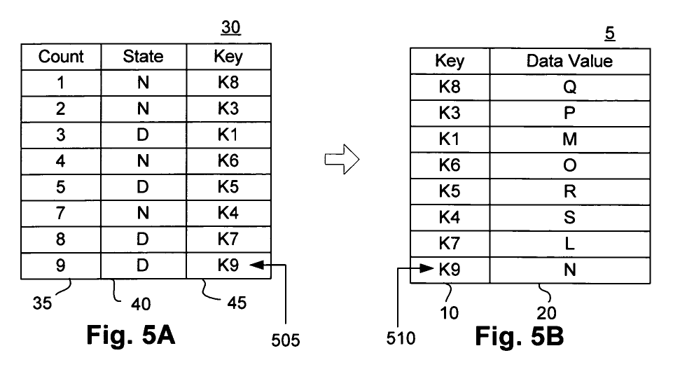

With reference to FIGS. 4, 5A, 5B and 9, at 965, the process continues by searching for an entry in the list that can be deleted. The first entry in FIG. 4, having a key of K2 can be deleted since the corresponding row in the cache is not dirty, as indicated by the state of N in the entry, and so at 975 the entry is removed at that location. In one embodiment of the invention, the entry having a state of N and the oldest count value is deleted, e.g., the entry having a key of K8 and a count value of 1, the trade-off being searching all of the not dirty records to find the oldest such record rather than deleting the first not dirty record encountered by the search. Once an entry in the list is deleted and the corresponding row in the cache also deleted to make room for a new entry in the list and corresponding cache, the remaining entries in the list are sorted at 980 based on count, as depicted in FIG. 5B (note no entry in the list in FIG. 5B that has a key of K2). The cache remains unsorted, as depicted in FIG. 5A (note further no row in the cache that has a key of K2). The list of entries is now sorted in order of the least recently used to most recently used entries (and corresponding cache rows), and the new entry is then appended at 985 to the end of the list, at entry 505 (FIG. 5A), and the corresponding new row is added to the cache at row 510 (FIG. 5B).

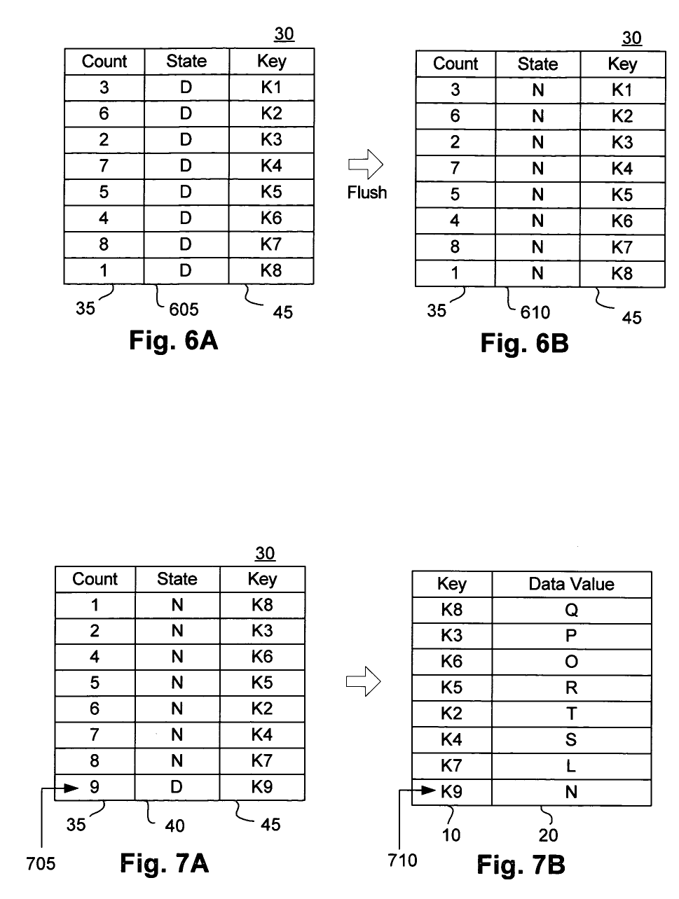

If at 970 an entry is not found that can be deleted, that is, if all entries are dirty and their corresponding rows in the cache need to be written to permanent storage before an entry in the list can be deleted (see, e.g., FIG. 6A, wherein all entries have a state of D), the cache is flushed (written) to permanent store at 990. FIG. 6B depicts the list after the cache has been flushed. Note all entries have a state of N, indicating all corresponding rows in the cache are not dirty. Alternatively, an error can be returned to an application indicating the cache is full. After flushing the cache, processing returns to 960 and the process repeats as described above with reference to 960-985. After sorting and searching at 960 and 965, the first not dirty entry found in the list is deleted at 975—see resulting list in FIG. 7A, wherein the first entry from FIG. 6B that has a key of K1 is removed. The list is then sorted by count and a new entry appended to the end of the list at entry 705. A corresponding row in the cache that has the same key is also appended to the end of the cache at 710.

Numerous specific details are set forth in this description in order to provide a thorough understanding of the embodiments of the invention. It is apparent, however, to one skilled in the art that the invention may be practiced without some of these specific details. In other instances, well-known structures and devices have been shown in block diagram form to avoid obscuring the underlying principles of the invention.

Various embodiments of the invention may be performed by hardware components or may be embodied in machine-executable instructions, which may be used to cause a general-purpose or special-purpose processor or a machine or logic circuits programmed with the instructions to perform the various embodiments. Alternatively, the various embodiments may be performed by a combination of hardware and software.

Various embodiments of the invention may be provided as a computer program product, which may include a machine-readable medium having stored thereon instructions, which may be used to program a computer (or other electronic devices) to perform a process according to various embodiments of the invention. The machine-readable medium may include, but is not limited to, floppy diskette, optical disk, compact disk-read-only memory (CD-ROM), magneto-optical disk, read-only memory (ROM) random access memory (RAM), erasable programmable read-only memory (EPROM), electrically erasable programmable read-only memory (EEPROM), magnetic or optical card, flash memory, or another type of media/machine-readable medium suitable for storing electronic instructions. Moreover, various embodiments of the invention may also be downloaded as a computer program product, wherein the program may be transferred from a remote computer to a requesting computer by way of data signals embodied in a carrier wave or other propagation medium via a communication link.

What is claimed is:

1. A method of updating a data cache having a plurality of rows, the method comprising:
maintaining a list of the rows, the list comprising a plurality of entries, each entry corresponding to a row and comprising a key uniquely identifying the row, and a count indicating an age of the row;
sorting the entries by their key;
searching the list for an entry having a key to a row to be updated if found or added if not found;
if the entry having the key to the row to be updated is found:
removing the entry from the list;
sorting the remaining entries by their count, so that the entry at the beginning of the list is for the oldest row, and the entry at the end of the list is for the newest row;
appending a new entry at the end of the list that replaces the removed entry, the new entry having the same key as the removed entry, and a count indicating the corresponding row is the newest; and
updating the corresponding row in the data cache.

2. The method of claim 1, wherein searching the list comprises performing a binary search using the key of the row to be updated.

3. The method of claim 1, wherein the count comprises a timestamp of when the row was added to, or last updated in, the data cache.

4. The method of claim 1, wherein the count comprises a value that indicates the relative age of the row compared to the age of other rows in the data cache.

5. The method of claim 1, wherein if the entry having the key to the row to be added is not found:
sorting the entries by their count, the entry at the beginning of the list corresponding to the oldest row, the entry at the end of the list corresponding to the newest row;
appending a new entry to the end of the list, the new entry having the key to the row to be added; and
adding the row to the data cache.

6. The method of claim 5, further comprising examining whether the data cache is full and performing the sorting by count, appending the new entry, and adding the row only if the data cache is not full.

7. The method of claim 1, wherein each entry further comprises a state of the row, the method further comprising:
if the entry having the key to the row to be added is not found, and if the data cache is full:
sorting the entries by their state;
searching the list for an entry to remove based on its state;
if an entry to remove based on its state if found:
removing the entry from the list;
sorting the remaining entries by their count; and
appending a new entry to the end of the list, the end of the list corresponding to the newest row, the new entry having the key to the row to be added; and
adding the corresponding row to the data cache.

8. The method of claim 7, further comprising:
if an entry to remove based on its state is not found:
writing the rows of the data cache to a storage;
sorting the entries by their state;
searching the list for an entry to remove based on its state;
if an entry to remove based on its state is found:
removing the entry from the list;
sorting the remaining entries by count;
appending a new entry to the end of the list, the new entry having the key to the row to be added; and
adding the row to the data cache;
if the entry to remove is not found, providing an indication of such.

9. The method of claim 8, wherein sorting the entries based on their state comprises sorting the entries based on whether their states indicate their respective rows have been modified but not yet written to the storage.

10. The method of claim 9, wherein searching the list for an entry to remove based on its state comprises searching the list for an entry having a state that indicated its corresponding row has been written to storage since last being modified.

11. The method of claim 11, wherein searching the list for an entry having a state that indicates is corresponding row has been written to storage since last being modified comprises searching the list for an oldest such entry.

12. The method of claims 8, wherein writing the rows of the data cache to a storage comprises writing only those rows whose corresponding entry has a state that indicates the row has not been written to storage since last being modified.

13. The method of claims 8, wherein the storage comprises a persistent data store.

14. The method of claim 13, wherein the persistent data store comprises a database.

15. An article of manufacture, comprising a computer accessible medium providing instructions that when executed by a computer cause the computer to perform the method of claim 1.

16. An article of manufacture, comprising a computer accessible medium providing instructions that when executed by a computer cause the computer to perform the method of claim 5.

17. An article of manufacture, comprising a computer accessible medium providing instructions that when executed by a computer cause the computer to perform the method of claim 7.

18. An article of manufacture, comprising a computer accessible medium providing instructions that when executed by a computer cause the computer to perform the method of claim 8.

19. An article of manufacture, comprising a computer accessible medium providing instructions that when executed by a computer cause the computer to perform the method of claim 11.

20. An article of manufacture, comprising a computer accessible medium providing instructions that when executed by a computer cause the computer to perform the method of claim 12.
